(19) United States
(12) Patent Application Publication
(10) Pub. No.: US 2025/0108930 A1
(43) Pub. Date: Apr. 3, 2025

(54) SYSTEM HAVING A MECHANICAL CONNECTION DEVICE WITH TWO MECHANICAL TORQUE TRANSMISSION PATHS

(71) Applicant: AIRBUS HELICOPTERS, Marignane Cedex (FR)

(72) Inventors: Jean-Victor LAPEYRE, Lancon-Provence (FR); Luca COSSETTI, Alleins (FR)

(73) Assignee: AIRBUS HELICOPTERS, Marignane Cedex (FR)

(21) Appl. No.: 18/774,374

(22) Filed: Jul. 16, 2024

(30) Foreign Application Priority Data
Sep. 29, 2023 (FR) 2310437

(51) Int. Cl. B64D 35/022; F16D 3/06; F16D 9/06; F16D 11/14; F16D 48/06; F16D 127/02

(52) U.S. Cl. CPC B64D 35/022; F16D 3/06; F16D 9/06; F16D 11/14; F16D 48/06; F16D 2127/02

(57) ABSTRACT

A system comprising a connection device having a first shaft and a second shaft, the connection device comprising a free-wheel interposed between the first shaft and the second shaft that can only transmit engine torque from the first shaft to the second shaft when a motor mode is activated. The connection device comprises a coupler, the coupler being provided with a fusible section, the connection device comprising a dog clutch connection that can only transmit engine torque from the coupler to the first shaft when an electrical power generation mode is activated.

### CROSS REFERENCE TO RELATED APPLICATIONS

This application claims priority to French Patent Application No. FR 23 10437 filed on Sep. 29, 2023, the disclosure of which is incorporated in its entirety by reference herein.

### TECHNICAL FIELD

The present disclosure relates to a system having a mechanical connection device with two mechanical torque transmission paths. For example, a vehicle may be provided with a mechanical device connected to a hybrid power plant, this hybrid power plant having at least one electric machine connected to the mechanical device by such a mechanical connection device.

### BACKGROUND

In particular, the mechanical device may comprise at least one rotor set in motion by a gearbox for contributing to the lift and/or the propulsion of this aircraft. By way of illustration, the aircraft may comprise a gearbox that sets at least one main rotor in motion in order to ensure at least partial lift or propulsion, or a rotor that helps control yaw motion.

A hybrid combustion/electric power plant may be connected to the mechanical device in order to set it in motion and may, in particular, be connected to the gearbox according to the aforementioned example.

This hybrid power plant comprises at least one heat engine. The expression “heat engine” denotes turboshaft engines or indeed all internal combustion engines, in particular piston engines, that may be used in such a power plant. The term “heat engine” is used in contrast to the term “electric motor”, that describes motors that consume only electrical energy.

The hybrid power plant also comprises at least one electric machine. Such an electric machine may operate in an electric motor mode, converting electrical energy into mechanical energy in order to help set the gearbox in motion, but also in an electrical power generation mode, converting extracted mechanical energy into electrical energy that can be transmitted to an electricity network of the aircraft.

Document FR 3106570 describes a rotary-wing aircraft comprising at least one heat engine and a backup electric motor.

Moreover, the electric machine may be controlled, depending on the flight phase, to operate either in the electric motor mode or in the electrical power generation mode. The mechanical power transmitted to the mechanical device in the electric motor mode may be different from the mechanical power that can be extracted during application of the electrical power generation mode.

Furthermore, the electric machine may be subject to a risk of internal jamming. In order to solve this problem, the electric machine may be connected to the mechanical device by a mechanical connection device that can disengage the mechanical device from the electric machine. This mechanical connection device may, for example, kinematically disengage the electric machine from the mechanical device in the event of jamming.

Document EP 3693627 B1 does not belong to the technical field of the disclosure and does not provide a solution to the aforementioned problem. Indeed, document EP 3693627 B1 relates to a selectable clutch device positioned between a main drive system and a secondary drive system, the main drive system having gearboxes and a main engine, such as a turboshaft engine. The secondary drive system has a secondary engine, such as a turboshaft engine. The selectable clutch device comprises an input pinion secured to an outer ring. A free-wheel is interposed between the outer ring and an inner ring constrained to rotate with an output pinion. The selectable clutch device comprises a bypass assembly for constraining the outer ring and the inner ring in rotation in a coupled mode, and rotationally disengaging the outer ring and the inner ring in an uncoupled mode. The bypass assembly comprises a member comprising splines that engage with splines of the inner ring. The bypass assembly also comprises an actuator for linking splines of said member with splines of the outer ring, on request. In the uncoupled mode, the selectable clutch device operates in a unidirectional torque transfer mode, transferring torque from the input pinion to the output pinion. In a coupled mode, the selectable clutch device operates in a bi-directional torque transfer mode, transferring torque between the input pinion and the output pinion via the bypass assembly.

Document FR3122407 discloses a system for transmitting an engine torque from a main shaft of an electric machine operating in motor mode to a secondary shaft, and alternatively another engine torque from the secondary shaft to the main shaft of the electric machine operating in generation mode. This system comprises two free-wheels arranged in phase opposition.

Document DE 10 2015 214266 relates to a mechanical power transmission system for a motor vehicle for driving a power transmission system using a heat engine and an electric motor. A torque transmission device connects the heat engine and a transmission shaft of the power transmission system, the electric motor being connected to this transmission shaft by a dedicated drive device, for example with a belt. A dual-mass flywheel is interposed between the heat engine and the torque transmission device. A starter clutch is interposed between the torque transmission device and electric motor and the power transmission system. The torque transmission device comprises a separating clutch provided with two coupling components that can be connected to each other by a positive connection and a free-wheel.

Document U.S. Pat. No. 9,447,734 discloses an aircraft provided with at least one rotor driven by a gearbox, at least one heat engine and at least one electric machine operating in “electric motor” mode and in “electrical power generation” mode. Each electric machine is mechanically connected to the gearbox by a first connection means and to a gas generator of a heat engine by a second connection means. The electric machine may be mechanically connected by the same shaft to a dedicated input of the gearbox via the first connection means, and to a gas generator via the second connection means. Alternatively, the electric machine may be interposed between a free turbine of a heat engine and the gearbox. The first connection means may comprise a clutch or a lockable free-wheel.

Document DE 10 2022 209300 describes a drive system for an electric vehicle comprising two speeds and a dog clutch having a free-wheel function. The dog clutch comprises an inner element whose end face is provided with pull claws, and an outer element that radially surrounds the inner element at least partially and is provided with push claws on its end face. The pull claws and the push claws have oppositely inclined wedge structures, and the inner element and the outer element can move axially, with their respective claws, towards a coupling element having a toothed ring gear. The inner element transmits torque in a first direction, whereas the outer element transmits torque in a second opposing direction. If the two elements are inserted at the same time, torque can be transmitted in both directions, as with a conventional dog clutch.

Document US 2022/136594 describes a powertrain for a motor vehicle comprising one or more electric motors and a unidirectional clutch fixedly mounted on a first rotating shaft, a dog clutch mounted so as to be able to slide on the first rotating shaft and designed to rotate with the first rotating shaft, a clutch ring positioned between the unidirectional clutch and the dog clutch, and a second rotating shaft constrained to rotate with the clutch ring. The clutch ring is designed to transfer rotational movement from the second rotating shaft through the unidirectional clutch and the dog clutch to the first rotating shaft.

### SUMMARY

An object of the present disclosure is thus to propose an innovative mechanical connection device that is designed to limit the risk of the mechanical device jamming in the event of the electric machine jamming and to limit the risk of fire in the event of the electric machine short-circuiting.

The disclosure therefore relates to a transmission system provided with a mechanical device connected to a power plant, said power plant comprising an electric machine that can operate in a motor mode for setting the mechanical device in motion and in an electrical power generation mode by being set in motion by the mechanical device, the electric machine being kinematically connected to the mechanical device by a bi-directional connection device, the connection device comprising a first shaft kinematically connected to the electric machine and a second shaft kinematically connected to the mechanical device, the second shaft being able to rotate about an axis of rotation in a first direction of rotation, the connection device comprising a free-wheel interposed between the first shaft and the second shaft to only transmit engine torque from the first shaft to the second shaft when the motor mode is activated.

This bi-directional connection device comprises a coupler, the coupler being provided with a fusible section, the coupler being constrained to rotate with the second shaft about said axis of rotation, the connection device comprising a dog clutch connection that can only transmit engine torque from the coupler to the first shaft when the electrical power generation mode is activated.

The engine torque transmitted by the dog clutch connection when the electrical power generation mode is activated may be referred to as generator torque in order to distinguish it from the engine torque transmitted by the free-wheel when the motor mode is activated.

The dog clutch connection and the free-wheel can therefore provide two different mechanical torque transmission paths in two different operating modes.

When the motor mode is activated, the first shaft is set in motion by the electric machine. The connection device transmits engine torque from the first shaft to the second shaft via the free-wheel due to the dimensions of the dog clutch connection. The dog clutch connection is in this case inoperative. Therefore, if the electric machine jams, this does not cause the mechanical device to jam, because of the free-wheel and the fusible section. If the electric machine jams, the free-wheel will become desynchronized and cause a change in the transmission of forces, applying stress to the fusible section. If no action is taken, the fusible section will eventually break and disengage the electric machine from the mechanical device.

When the electrical power generation mode is activated, the second shaft is set in motion by the mechanical device. The connection device transmits engine torque from the second shaft to the first shaft via the dog clutch connection. The free-wheel is then desynchronized. If the electric machine jams, the fusible section can break in order not to hinder the operation of the mechanical device.

This separation of the mechanical torque transmission paths allows the fusible section to be arranged within the coupler. Indeed, separating the mechanical torque transmission paths makes it possible to determine the dimensions of the fusible section accurately and easily, in particular in the event that the power transmitted by the connection device when the electrical power generation mode is activated is less than the power transmitted in the connection device when the motor mode is activated. By way of illustration, the connection device can transmit mechanical power of the order of 250 to 300 kilowatts when the motor mode is activated, and of the order of 30 to 50 kilowatts when the electrical power generation mode is activated.

Such a connection device may also be compact, and/or relatively lightweight, and/or may be arranged relatively easily within an existing architecture.

The transmission system may, for example, comprise one or more of the following features, taken individually or in combination.

The coupler may comprise an intermediate shaft provided with the fusible section and constrained to rotate with the second shaft about the axis of rotation, said intermediate shaft being connected to the first shaft by the dog clutch connection, the dog clutch connection having at least a non-zero rotational clearance about the axis of rotation in the direction of rotation.

This clearance prevents the intermediate shaft from being driven by the first shaft when the motor mode is activated, so as to separate the power transmission paths in the connection device.

According to one possibility compatible with the preceding possibilities, the dog clutch connection may comprise several first teeth that are constrained to rotate with the first shaft about the axis of rotation and several second teeth that are constrained to rotate with the intermediate shaft about the axis of rotation, each second tooth being arranged on an arc of a circle centered on the axis of rotation between an upstream first tooth and a downstream first tooth and being separated from the upstream first tooth by the clearance, the upstream first tooth being upstream of the downstream first tooth as seen by an observer during rotation in the direction of rotation about the axis of rotation of the first shaft.

For example, such a clearance may be defined angularly by an angle of between 45° and 60°.

The coupler is therefore simple and compact.

According to one possibility compatible with the preceding possibilities, said intermediate shaft may comprise first splines that engage with second splines of the second shaft.

According to one possibility compatible with the preceding possibilities, the connection device may comprise an elastic return system interposed between the intermediate shaft and the second shaft, the elastic return system pushing the coupler into a predetermined coupled position allowing the dog clutch connection to transmit engine torque only from the coupler to the first shaft.

For example, the return system tends to bring certain first teeth and second teeth into contact.

According to one possibility compatible with the preceding possibilities, said connection device may comprise an actuator configured to move the coupler in translation from a predetermined coupled position allowing the dog clutch connection to transmit engine torque from the coupler to the first shaft to a predetermined uncoupled position inhibiting the dog clutch connection.

Such an actuator may be a hydraulic, pneumatic or electrical actuator, for example. Such an actuator may be in the form of a jack, for example. The actuator prevents engine torque from being transmitted from the second shaft to the first shaft, for safety reasons, and in particular in the event of a short circuit in the electric machine when the electrical power generation mode is activated. Such an actuator can also be used to check the operation of the connection device when testing prior to use.

The actuator may be controlled by a controller, for example to move the coupler to the uncoupled position in the event of the electric machine jamming or short-circuiting. To this end, the system may comprise at least one sensing device for detecting such an event, such as a current sensor and/or a rotational speed sensing device, for example.

According to one possibility compatible with the preceding possibilities, the power plant may comprise at least one heat engine kinematically connected to the mechanical device.

The disclosure also relates to an aircraft comprising such a transmission system.

For example, the mechanical device comprises a gearbox, the gearbox setting at least one lift and/or propulsion rotor in motion.

### BRIEF DESCRIPTION OF THE DRAWINGS

The disclosure and its advantages appear in greater detail in the context of the following description of embodiments given by way of illustration and with reference to the accompanying figures, wherein:

FIG. 1 is a diagram showing a connection device according to the disclosure provided with an actuator;

FIG. 2 is a three-dimensional view of the dog clutch connection of FIG. 1;

FIG. 3 is a diagram showing a connection device according to the disclosure arranged, for example, in a transmission system, for example arranged in an aircraft;

FIG. 4 is a diagram showing a connection device according to the disclosure provided with an actuator in a coupled position; and

FIG. 5 is a diagram showing a connection device according to the disclosure provided with an actuator in an uncoupled position.

### DETAILED DESCRIPTION

Elements that are present in more than one of the figures are given the same references in each of them.

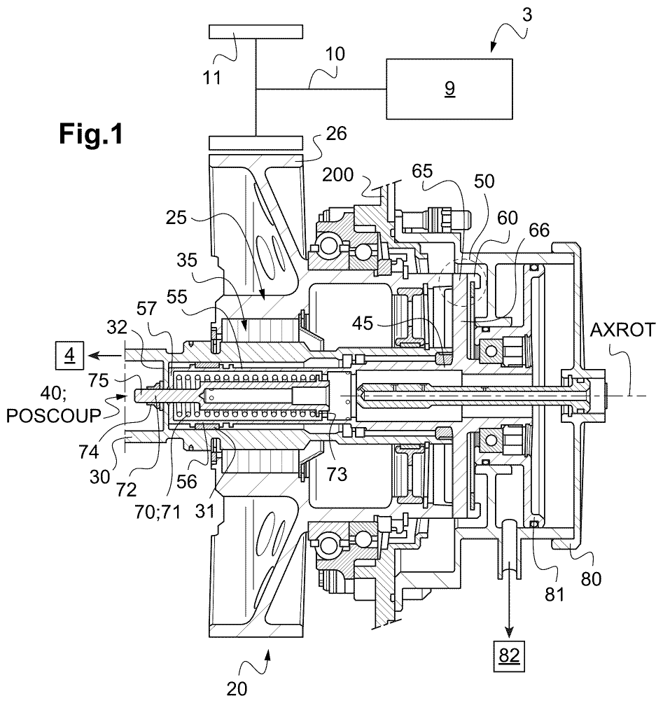

FIG. 1 shows a bi-directional connection device 20. This connection device 20 comprises a first shaft 25 and a second shaft 30 that are able to rotate about the same axis of rotation AXROT. The term “shaft” denotes a mechanical member transmitting power in the form of torque and a rotational movement, this member being able to comprise one or more components.

The connection device 20 may be arranged in any system that requires bi-directional transmission of power between two assemblies.

According to the example, the first shaft 25 may be kinematically connected to an electric machine 9 of a transmission system 3.

For example, the first shaft 25 may therefore be constrained to rotate about the axis of rotation AXROT with a first pinion 26 connected to the electric machine 9 by a mechanical line. According to the possibility shown in FIG. 1, the electric machine 9 comprises a power shaft 10 secured to an input/output pinion 11 engaged with the first pinion 26.

According to another aspect, the first shaft 25 may be carried by a structure 200.

Such an electric machine 9 is configured to operate in a motor mode MODMOT for setting the first shaft 25 in motion and in an electrical power generation mode MODGEN by being set in motion by the first shaft 25.

For example, the electric machine 9 is controlled in a conventional manner by a computer or a human-machine interface. The transmission system may comprise at least one sensing device (sensor) issuing a signal carrying information relating to the operation of the electric machine 9. For example, the system comprises a current sensing device measuring an electric current in the electric machine 9, a speed sensing device measuring a rotational speed of an internal member of the electric machine 9, or the like.

Moreover, the second shaft 30 may be kinematically linked/connected by conventional means to a mechanical device 4 of the transmission system 3.

According to another aspect, the connection device 20 is provided with a free-wheel 35 interposed between the first shaft 25 and the second shaft 30. The free-wheel 35 is configured to transmit engine torque only from the first shaft 25 to the second shaft 30 when the motor mode is activated, when the first shaft is rotating, in a direction referred to as the “direction of rotation”, about the axis of rotation AXROT. The free-wheel is then synchronized. When the motor mode is activated, the first shaft 25 therefore represents a drive shaft setting in rotation, via the free-wheel 35, the second shaft 30 that forms a driven shaft.

Such a free-wheel 35 may be a conventional free-wheel with ramps or pawls, for example. By way of illustration, the free-wheel 35 may comprise an outer ring provided with ramps and constrained to rotate about the axis of rotation AXROT with the first shaft 25, an inner ring constrained to rotate about the axis of rotation AXROT with the second shaft 30, and rolling members arranged between the outer ring and the inner ring.

Therefore, when the free-wheel 35 is synchronized, the first shaft 25 sets the second shaft 30 in rotation about the axis of rotation AXROT in the direction of rotation.

However, if the second shaft 30 rotates more quickly than the first shaft 25 in the direction of rotation, the free-wheel 35 is desynchronized.

In order to set the first shaft 25 in rotation with the second shaft 30 about the axis of rotation AXROT and always in the direction of rotation, when the electrical power generation mode is activated, the connection device 20 comprises a coupler 40. The term “coupler” denotes a device configured to transmit engine torque only from the second shaft 30 to the first shaft 25 when the electrical power generation mode is activated, unlike the free-wheel 35.

To this end, the connection device 20 has a dog clutch connection 50 configured to only transmit engine torque from the coupler 40 to the first shaft 25 when the electrical power generation mode is activated.

Moreover, the coupler is provided with a fusible section 45 for disengaging the first shaft 25 from the second shaft 30 in the event of this first shaft 25 jamming.

According to one possibility, the coupler 40 has an intermediate shaft 55 provided with the fusible section 45. The fusible section 45 is produced by locally reducing the thickness of the intermediate shaft 55, for example.

This intermediate shaft 55 may be constrained to rotate about the axis of rotation AXROT with the second shaft 30. According to the example shown, the intermediate shaft 55 comprises first splines 56 engaged with second splines 31 of the second shaft 30.

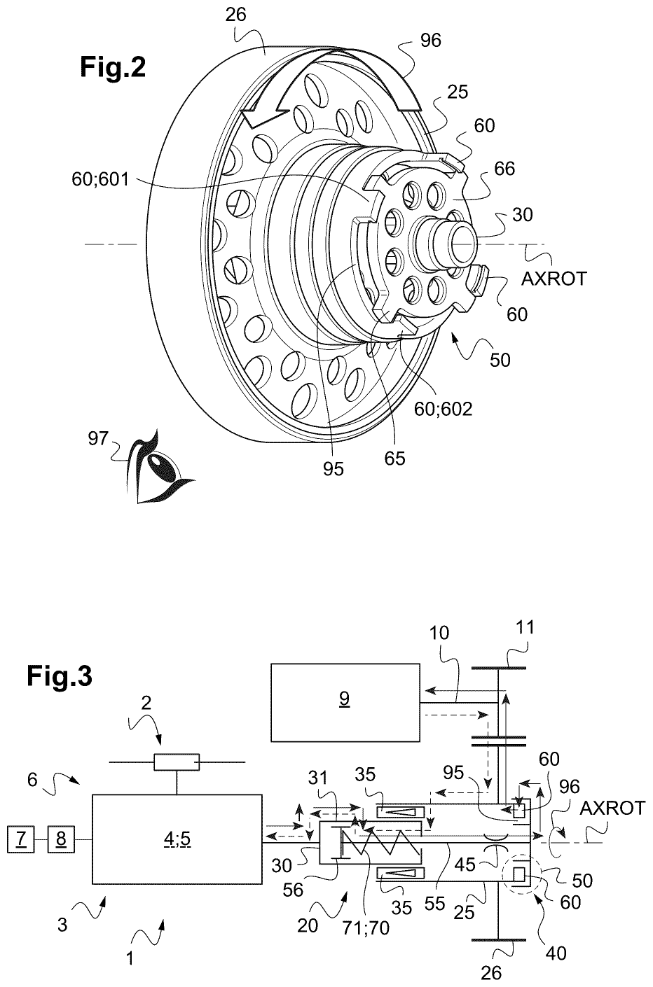

Moreover, the purpose of the dog clutch connection 50 is to constrain the intermediate shaft 55 and the first shaft 25 in rotation about the axis of rotation AXROT, only when the electrical power generation mode is activated and not in the event of a failure. In reference to FIG. 2, the dog clutch connection 50 has at least a non-zero functional clearance 95 in rotation about the axis of rotation AXROT in a first direction of rotation 96, so as not to be able to constrain the first shaft 25 and the second shaft 30 in rotation when the motor mode is activated, at least when there is no malfunction.

In particular, the dog clutch connection 50 comprises several first teeth 60 constrained to rotate with the first shaft 25 about the axis of rotation AXROT. The first teeth may be arranged in a circle centered on the axis of rotation AXROT, being spaced apart at equal intervals, for example. Each first tooth 60 may extend from one end of the first shaft 25 parallel to the axis of rotation AXROT.

The dog clutch connection 50 also comprises several second teeth 65 constrained to rotate with the intermediate shaft 55 about the axis of rotation AXROT. The second teeth 65 may be arranged on said circle centered on the axis of rotation AXROT, being spaced apart at equal intervals, for example. Each second tooth 65 may extend radially in relation to the axis of rotation AXROT, from the intermediate shaft 55 or from a disk 66 secured to the intermediate shaft 55.

Each second tooth 65 is also arranged on an arc of a circle centered on the axis of rotation AXROT between an upstream first tooth 601 and a downstream first tooth 602. The expressions “upstream tooth” and “downstream tooth” are to be considered as seen by an observer 97 when the first shaft 25 is rotating about the axis of rotation AXROT in the direction of rotation 96.

Each second tooth 65 is then separated from the corresponding upstream first tooth 601 by a clearance 95 sufficient to prevent the second tooth 65 from meshing with the associated upstream first tooth 601 when the motor mode is activated.

Moreover, and in reference once again to FIG. 1, the connection device 20 may comprise an elastic return system 70 interposed between the intermediate shaft 55 and the second shaft 30 to position the first teeth 60 and the second teeth 65, if necessary, on the same circle centered on the axis of rotation AXROT.

The elastic return system 70 is thus configured to push the coupler 40 into a predetermined coupled position POSCOUP allowing the dog clutch connection 50 to transmit engine torque only from the coupler 40 to the first shaft 25.

Such an elastic return system 70 may comprise a spring 71, for example, or the like.

According to the example shown in FIG. 1, the spring 71 may comprise a turn in contact with or fastened to an inner disk 57 secured to the intermediate shaft 55, and a turn in contact with or fastened to a connecting disk 73. The connecting disk 73 may be constrained to move in translation parallel to the axis of rotation AXROT with the second shaft 30. For example, the connecting disk 73 is formed by a shoulder of a locking pin 72 passing through the spring 71. The locking pin 72 may be provided with a fastening end 75 passing through a fastening disk 32 secured to the second shaft 30. A nut 74 may be screwed to the fastening end 75 so as to be pressed against the fastening disk 32.

According to another aspect, the connection device 20 may comprise an actuator 80 configured to move the coupler 40 in translation parallel to the axis of rotation AXROT from the coupled position POSCOUP to a predetermined uncoupled position POSDECOUP inhibiting the dog clutch connection 50, and vice versa. In the uncoupled position POSDECOUP, the first teeth 60 and the second teeth 65 are no longer present on the same circle centered on the axis of rotation AXROT.

The actuator 80 may be controlled by a controller 82, such a controller 82 that may comprise a human-machine interface and/or an autonomous computer possibly linked to the aforementioned sensing devices for monitoring the system. For example, such a computer is configured to transmit a signal to the actuator in order to place the dog clutch connection 50 in the uncoupled position POSDECOUP in the event of the electric machine jamming or short-circuiting or when the motor mode is activated.

The actuator 80 shown is a hydraulic actuator comprising a conventional hydraulic network that is not shown here and is within the capabilities of a person skilled in the art. Alternatively, the actuator 80 may be an electrical or pneumatic jack, for example.

FIGS. 3 to 5 show the operation of a connection device 20 according to the disclosure and an example of how it may be arranged in a transmission system 3.

This transmission system 3 is provided with a mechanical device 4 connected to a power plant 6.

The power plant 6 comprises the electric machine 9 that can operate in a motor mode for setting the mechanical device 4 in motion and in an electrical power generation mode by being set in motion by the mechanical device 4.

The electric machine 9 is kinematically connected to the mechanical device 4 by a connection device 20. In particular, the first shaft 25 is kinematically connected to the electric machine 9, and the second shaft 30 is kinematically connected to the mechanical device 4.

The power plant 6 possibly comprises at least one heat engine 7 connected in a conventional manner to the mechanical device 4, possibly via a free-wheel 8.

The transmission system 3 may be arranged in an aircraft 1. In particular, the mechanical device 4 may comprise a gearbox 5 setting at least one lift and/or propulsion rotor 2 in motion. The gearbox 5 may then be connected to the second shaft 30 or to the heat engine 7.

FIG. 3 shows, in particular, a connection device 20 with no actuator.

When the motor mode is activated, the electric machine 9 sets the first shaft 25 in rotation about the axis of rotation AXROT. The connection device 20 transmits mechanical power from the first shaft 25 to the second shaft 30, rotating in the direction of rotation 96, only via the free-wheel 35, as shown by the arrows in dotted lines. The clearance 95 prevents power from being transmitted by the coupler 40. Furthermore, the second shaft 30 helps set the gearbox 5 in motion, either in conjunction with the heat engine 7 or not. In the event of the electric machine 9 jamming, the fusible section may break and disengage the electric machine 9 from the mechanical device.

When the electrical power generation mode is activated, the second shaft 30 is set in rotation by the mechanical device 4. According to the example shown, the gearbox 5 is set in motion by the heat engine 7 and rotates the second shaft 30 about the axis of rotation AXROT. The connection device 20 transmits mechanical power from the second shaft 30 to the first shaft 25 only via the coupler 40, as shown by the arrows in solid lines. The first shaft 25 then rotates the input/output shaft 10 of the electric machine 9.

In the event of the electric machine 9 jamming, the fusible section 45 can break in order not to jam the mechanical device 4. Using a different power transmission path to that used in the motor mode allows such a fusible section 45 to be installed.

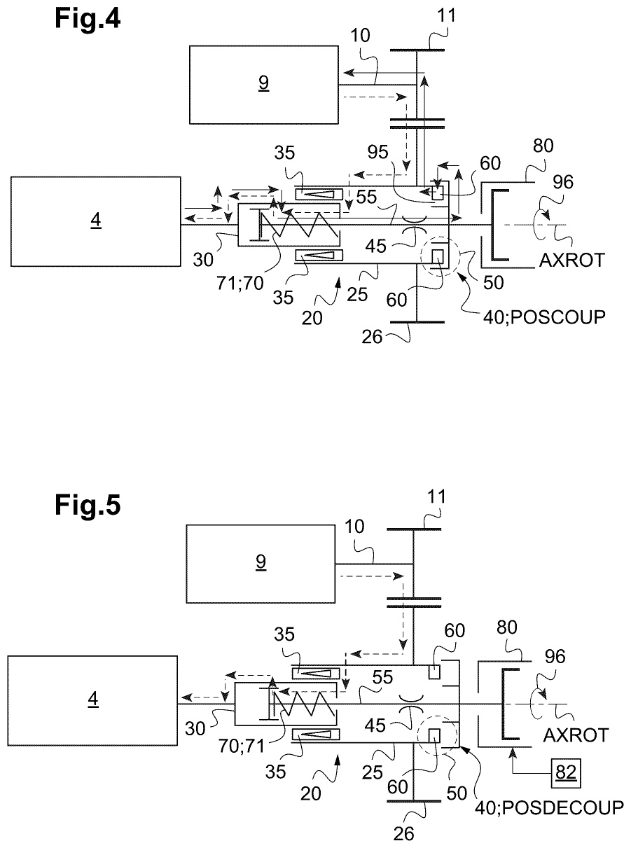

FIGS. 4 and 5 show a variant of the connection device 20 of FIG. 3 provided with an actuator 80.

In reference to FIG. 4, the actuator 80 can position the coupler 40 in a coupled position POSCOUP. The connection device 20 then operates in the same way as in FIG. 3.

When commanded to do so by a control 82, the actuator 80 can position the coupler 40 in an uncoupled position POSDECOUP shown in FIG. 5. The coupler 40 is moved in translation parallel to the axis of rotation AXROT in order to inhibit the dog clutch connection 50. The elastic return system 70 is compressed. The electrical power generation mode is then prohibited for safety reasons.

Naturally, the present disclosure is subject to numerous variations as regards its implementation. Although several embodiments are described above, it should readily be understood that it is not conceivable to identify exhaustively all the possible embodiments. It is naturally possible to replace any of the means described with equivalent means without going beyond the ambit of the present disclosure.

What is claimed is:

1. A transmission system provided with a mechanical device connected to a power plant, the power plant comprising an electric machine that can operate in a motor mode for setting the mechanical device in motion and in an electrical power generation mode by being set in motion by the mechanical device, the electric machine being kinematically connected to the mechanical device by a bi-directional connection device, the connection device comprising a first shaft kinematically connected to the electric machine and a second shaft kinematically connected to the mechanical device, the second shaft being able to rotate about an axis of rotation in a first direction of rotation, the connection device comprising a free-wheel interposed between the first shaft and the second shaft to only transmit engine torque from the first shaft to the second shaft when the motor mode is activated,
wherein the bi-directional connection device comprises a coupler provided with a fusible section, the coupler being constrained to rotate with the second shaft about the axis of rotation, the connection device comprising a dog clutch connection that can only transmit engine torque from the coupler to the first shaft when the electrical power generation mode is activated.

2. The transmission system according to claim 1,
wherein the coupler comprises an intermediate shaft provided with the fusible section and constrained to rotate with the second shaft about the axis of rotation, the intermediate shaft being connected to the first shaft by the dog clutch connection, the dog clutch connection having at least a non-zero rotational clearance about the axis of rotation in the direction of rotation.

3. The transmission system according to claim 2,
wherein the dog clutch connection comprises several first teeth that are constrained to rotate with the first shaft about the axis of rotation and several second teeth that are constrained to rotate with the intermediate shaft about the axis of rotation, each second tooth being arranged on an arc of a circle centered on the axis of rotation between an upstream first tooth and a downstream first tooth and being separated from the upstream first tooth by the clearance, the upstream first tooth being upstream of the downstream first tooth as seen by an observer during rotation in the direction of rotation about the axis of rotation of the first shaft.

4. The transmission system according to claim 2,
wherein the intermediate shaft comprises first splines that engage with second splines of the second shaft.

5. The transmission system according to claim 2,
wherein the connection device comprises an elastic return system interposed between the intermediate shaft and the second shaft, the elastic return system pushing the coupler into a predetermined coupled position allowing the dog clutch connection to transmit engine torque only from the coupler to the first shaft.

6. The transmission system according to claim 1,
wherein the connection device comprises an actuator configured to move the coupler in translation from a predetermined coupled position allowing the dog clutch connection to transmit engine torque from the coupler to the first shaft to a predetermined uncoupled position inhibiting the dog clutch connection.

7. The transmission system according to claim 1,
wherein the power plant comprises at least one heat engine kinematically connected to the mechanical device.

8. An aircraft,
wherein the aircraft comprises the transmission system according to claim 1.

9. The aircraft according to claim 8,
wherein the mechanical device comprises a gearbox, the gearbox setting at least one lift and/or propulsion rotor in motion.
